(19) United States
(12) Patent Application Publication
(10) Pub. No.: US 2003/0161081 A1
(43) Pub. Date: Aug. 28, 2003

(54) Electronic microcomponent including a capacitive structure, and process for producing it

(75) Inventor: Lionel Girardie, Eybens (FR)

Correspondence Address: HESLIN ROTHENBERG FARLEY & MESITI PC, 5 COLUMBIA CIRCLE, ALBANY, NY, 12203, US

(73) Assignee: MEMSCAP Le Parc Technologique des Fontaines, Bernin (FR)

(21) Appl. No.: 10/374,354

(22) Filed: Feb. 25, 2003

(30) Foreign Application Priority Data
Feb. 27, 2002 (FR) 02 02461

(51) Int. Cl. H01G 2/12

(52) U.S. Cl. 361/15

(57) ABSTRACT

An electronic component produced from a substrate and incorporating a capacitive structure formed on top of the final visible metallization level produced in the substrate, said capacitive structure having two electrodes, wherein one of the electrodes comprises an array of superposed fins that are offset from one another with respect to a central trunk, the other electrode comprising two arrays of fins, the fins of each of the latter arrays being interleaved with the fins of the first electrode and being joined together by a common wall, the two common walls themselves being joined together above the first electrode.

### TECHNICAL FIELD

The invention relates to the technical field of microelectronics. It relates more specifically to electronic microcomponents incorporating one or more capacitive structures forming microcapacitors. These components may in particular be used within the context of radiofrequency applications for example, and may especially be used as decoupling capacitors.

The invention relates more precisely to the structure of such a capacitor with the purpose of very greatly increasing its “capacitance”, that is to say its capacitance per unit area, and to do so without excessively increasing the fabrication costs.

### PRIOR ART

The production of microcapacitors or capacitive structures on semiconductor substrates has already been the subject of considerable development.

Various technologies have already come to light, and especially those that make it possible to produce capacitive structures formed from two electrodes formed by two metal layers separated by a layer of insulating material or dielectric. This type of capacitor is generally one with what is termed a MIM (Metal Insulator Metal) structure. The invention relates to this type of capacitive structure.

Among existing solutions, that disclosed in document FR 2 801 425 relates to a microcapacitor whose two electrodes are formed by flat metal layers. In this case, the value of the capacitance of the capacitor depends essentially on the type of dielectric used and on the facing area of the two metal electrodes. In other words, the “capacitance” or the capacitance per unit area, is predominantly determined by the thickness of the insulating layer and its relative permittivity. Thus, to increase the capacitance, it is necessary either to choose particularly insulating materials or to reduce the distance between the electrodes, with the risk of breakdown phenomena, or even tunnel effects, occurring. In other words, the capacitors produced according to the structure described in that document are limited in terms of capacitance.

The Applicant has disclosed in French patent application No. 02/01618, not yet published at the date of filing of the present application, a novel capacitor structure produced on a level of metallization of an electronic component. Each electrode of this capacitive structure comprises a plurality of metal fins which are perpendicular to the principal plane of the substrate.

Another capacitive structure has been disclosed in document U.S. Pat. No. 5,834,357. This type of structure comprises a plurality of conducting fins, typically made of ruthenium dioxide (RuO₂), these being stacked on top of one another and separated by regions made of a different material, for example ruthenium (Ru). More specifically, a stack of alternating RuO₂ and Ru layers is produced, and then the Ru layers are etched so as to preserve the latter only around the central trunk. This type of capacitive structure therefore has the drawback that the electrodes combine layers of different materials, with electrical implications and complications in terms of the fabrication process.

It is one of the objects of the invention therefore to provide a capacitive structure which can be produced on the final visible level of metallization of an electronic microcomponent, which is easy to produce and which has a capacitance per unit area value that is appreciably higher than the values usually found.

### SUMMARY OF THE INVENTION

The invention therefore relates to an electronic microcomponent produced on a semiconductor substrate and incorporating a capacitive structure produced on top of the final visible level of metallization of the substrate. This capacitive structure has two electrodes of which, in accordance with the invention:

one of the electrodes comprises an array of superposed fins parallel to the plane of the substrate and offset from one another with respect to a central trunk;

the other electrode comprises two arrays of fins, the fins of each of these arrays being interleaved with the fins of the first electrode and being joined together by a common wall, the two common walls themselves being joined together above the first electrode.

In other words, the first electrode forms a tree structure, the trunk of which is formed by the superposition of the overlapping portions of each of the fins. The second electrode overlaps the first, forming a plurality of fins which are interleaved with the fins of the first electrode, these being located on either side of the central trunk. The facing area of each of the electrodes is therefore particularly high.

For the same area occupied on the substrate, this facing area may be increased by increasing the number of fins of each electrode, thereby making it possible to increase the capacitance at will.

In practice, the electrodes are separated by a dielectric layer produced from materials which are advantageously chosen from the group of ferroelectric and pyroelectric oxides. Among these ferroelectric oxides, the following are known: hafnium dioxide, tantalum pentoxide, zirconium dioxide, lanthanum oxides, diyttrium trioxide, alumina, titanium dioxide, and strontium titanates and tantalates (STO), barium strontium titanates (BST), strontium bismuth tantalates (SBT), and lead zirconate titanates (PZT), lanthanide-doped lead zirconate titanates (PLZT), strontium bismuth niobates (SBN), strontium bismuth tantalate niobates (SBTN), barium yttrium cuprates and manganese alkoxides such as Me₂MnO₃.

This dielectric may be deposited either as a uniform layer of the same material or of an alloy of several materials.

However, in a preferred embodiment, the dielectric layer may also consist of the superposition of elementary layers of different materials forming a nanolaminate structure. In this case, each of the layers has a very small thickness, of the order of a few angstroms to a few hundred angstroms.

In a preferred embodiment, the stoichiometry of the materials varies from one elementary layer to another in the nanolaminate structure. Thus, by varying the stoichiometry of each layer, oxygen concentration gradients (and concentration gradients of other materials used) are created across a few atomic layers. The variation in band structure of each elementary layer of the nanolaminate structure consequently modifies the overall band structure of the alloys and of the ferroelectric and pyroelectric oxide compounds across only a few atomic layers.

In this way, particularly high relative permittivity values are obtained, which help to increase the capacitance.

In practice, the surface of each electrode will preferably be covered with a layer of an oxygen diffusion barrier material, typically based on titanium nitride, tungsten nitride, tantalum nitride, or else one of the following materials: TaAlN, TiAlN, MoN, CoW or TaSiN.

Advantageously, the various fins forming part of each of the electrodes are produced from the same material, which improves the electrical behavior of the capacitor, while in particular eliminating certain risks of causing defects.

In practice, the material used to form the electrodes may be tungsten, or more generally any conducting material possessing good electrical conductivity. The electrodes may thus be made of copper, which allows electrodeposition methods to be used.

The invention also relates to a process for fabricating such a capacitive structure. This capacitive structure is fabricated on a microcomponent, on top of the final visible metallization level produced in the substrate of the microcomponent.

According to the invention, the process comprises the following steps, consisting in:

depositing, on top of the metallization level, a metal layer for forming the bottom part of one of the two electrodes of the capacitive structure;

depositing, on top of the metal layer, a structuring layer so as to define a channel for receiving a metal deposit;

depositing, in the channel thus formed, a metal deposit;

repeating the previous two steps as many times as necessary, depending on the desired geometry of the capacitor, offsetting one on the other the position of the structuring layer in order to cover only part of the subjacent metal layer, so as also to offset the future metal deposits, and thus obtain a tree structure forming the first electrode;

depositing, on top of the first electrode, a layer of dielectric according to the compositions described above and especially as regards the nanolaminate structures; and

depositing, over the first electrode, a conducting material that will insinuate between the various metal layers of the first electrode.

### BRIEF DESCRIPTION OF THE FIGURES

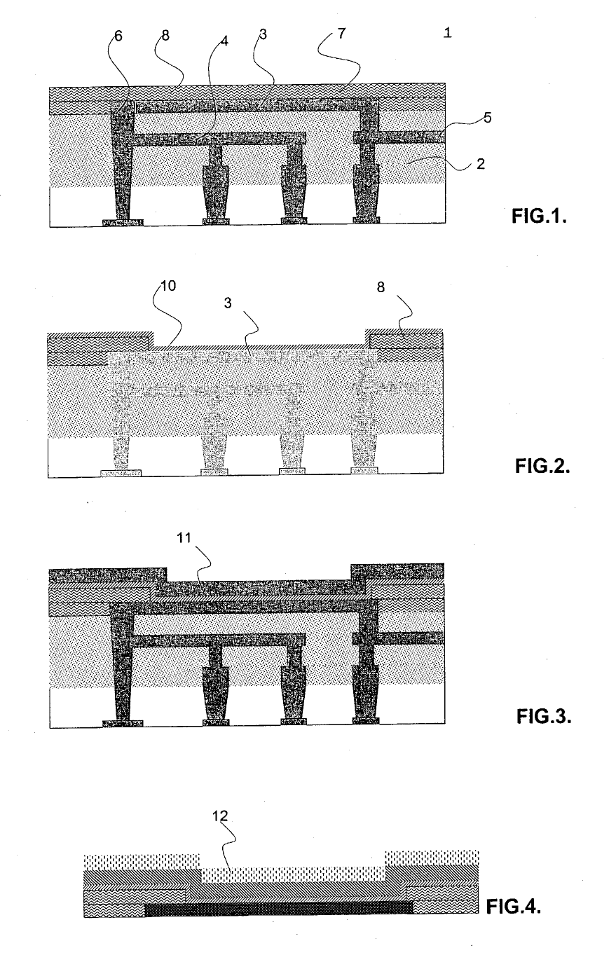

The manner in which the invention is realized, and the advantages that stem therefrom, will become clearly apparent from the description of the following embodiment, supported by the appended FIGS. 1 to 19 which are sectional views of the microcomponent according to the invention at the characteristic capacitive structure during the fabrication steps.

To simplify matters, FIGS. 4 to 18 show only the upper part of the component, in the region in which the capacitive structure is produced.

In general, the dimensions of the various actual layers and elements may differ from those of the layers and elements shown in the figures merely for the sake of making the invention understood.

### MANNER OF REALIZING THE INVENTION

As already mentioned, the invention relates to a microcomponent incorporating a microcapacitor produced with a specific structure, particularly one that is advantageous in terms of capacitance, that is to say capacitance per unit area.

Such a microcapacitor may be produced on a microcomponent (1) as illustrated in FIG. 1. To illustrate the possibility of producing the microcapacitor at various levels of the microcomponent, the substrate (2) illustrated in FIG. 1 comprises several metallization levels (3, 4, 5). The substrate (2) also includes an interconnection contact (6) emerging on the upper face (7) of the substrate. More precisely, this upper face (7) is covered with a passivation layer (8), typically made of SiO₂ or SiON. However, the invention is not limited to just this one embodiment of the range of microcomponents having an internal structure with several metallization levels.

Described below is one particular production process for obtaining the microcapacitor structure according to the invention. Certain steps of the process may nevertheless be considered as an ancillary or simply useful and advantageous for improving certain performance characteristics, without being absolutely necessary for remaining within the scope of the invention.

Thus, in a first step illustrated in FIG. 2, the passivation layer (8) is etched so as to expose the subjacent metallization level (3). When the passivation layer (8) is made of SiON, it may be etched by a conventional chemical etching process using a CF₄/O₂ or CF₄/H₂ mixture, or else by a technique of the RIE (Reactive Ion Etching) type, or else by using a radiofrequency plasma.

The process continues with a cleaning step for removing any remaining trace of SiON or of the products used for etching it. This cleaning may, for example, be carried out using a solution sold under the reference ACT 970 by Ashland. This cleaning may be followed by pre-rinsing with dissolution of carbon dioxide or ozone by bubbling, with a hydroxycarboxylic acid such as citric acid or oxalic acid.

Thereafter, an oxygen diffusion barrier layer (10) is deposited, as illustrated in FIG. 2. This diffusion barrier layer will act as an initiator layer for the deposition of the upper layers. This layer also serves to improve the resistance to electromigration and to oxygen diffusion. This layer may be deposited by an ALD (Atomic Layer Deposition) technique. The use of such a technique gives this diffusion barrier layer (10) very good thickness uniformity and excellent integrity. The materials that can be used for producing this diffusion barrier layer may be titanium nitride or tungsten nitride or tantalum nitride or else one of the following materials: TaAlN, TiAlN, MoN, CoW or TaSiN.

Thereafter, as illustrated in FIG. 3, a conducting layer intended to form the bottom fin of the central electrode is deposited. This layer (11) may be deposited by various known techniques. Among such techniques, mention may be made of the techniques known by the abbreviations PVD, E-BEAM, CVD and ALD, as well as electrolytic growth processes.

The materials that can be employed to produce this layer forming the base of the electrode (11) may be chosen from the group comprising tungsten, molybdenum, ruthenium, aluminum, titanium, nickel, gallium, palladium, platinum, gold, silver, niobium, iridium, iridium dioxide, ruthenium dioxide, yttrium, yttrium dioxide and copper. The thickness thus deposited is typically greater than 100 nanometers.

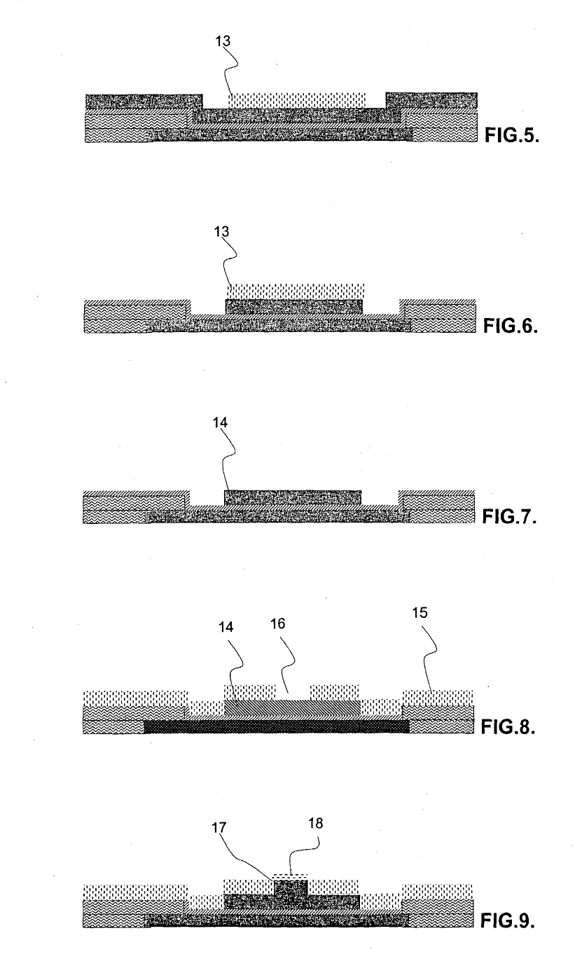

The process then continues, as illustrated in FIGS. 4 to 7, with various etching steps for defining, in the plane of the substrate, the position of the central electrode of the microcapacitor. These various steps are firstly divided, as illustrated in FIG. 4, by the deposition of a resist layer (12) covering the metal layer (11). Next, this layer (12) is irradiated and then removed from the peripheral regions, so as to remain only in the region (13) lying vertically above the first electrode, as illustrated in FIG. 5.

The process continues, as illustrated in FIG. 6, with the etching of the metal layer (11) outside the region protected by the resist layer (13). The latter is then removed, as illustrated in FIG. 7, so as to reveal the lower part (14) which will form the base of the first electrode. Thereafter, and as illustrated in FIG. 8, a structuring layer (15) is deposited which is used afterward to define various channels in which metal will be deposited for constructing the first electrode. A material will be chosen that can be etched so as to define walls that are relatively plane and perpendicular to the substrate. From among these materials, a photoresist may be chosen, such as in particular the resists sold under the references SJR 57-40 or SU 8 by Shipley and Clariant.

It is also possible to use a polyimide, and especially those sold by DuPont de Nemours, or photosensitive benzocyclobutene (BCB) manufactured by Dow Chemical. It is also possible to use a material sold under the reference CYCLOTENE DRYETCH Series 3 by Dow Chemical. It is also possible to deposit an SOG (spin-on glass) layer or else a layer of polysilicon or a layer of silicon oxide (SiO₂) or silicon oxynitride (SiON), which may be deposited by various chemical vapor deposition techniques such as PECVD (Plasma Enhanced Chemical Vapor Deposition), LPCVD (Low Pressure Chemical Vapor Deposition) or APCVD (Atmospheric Pressure Chemical Vapor Deposition).

The process continues, and again as illustrated in FIG. 8, with the definition of a central trench (16). made in the middle of the first metal fin (14). This central trench is obtained by lithography and/or etching so as to remove the structuring layer (15) until the layer (14) forming the bottom part of the electrode is revealed.

Thereafter, as illustrated in FIG. 9, metal is deposited in the trench (16) so as to define a stud (17) above the metal base (14). This stud (17) is then protected by depositing a photoresist (18). The process continues with a further deposition of a resist similar to that used to form the structuring layer (15). This new structuring layer is removed except in the region (19) lying on one side of the metal stud (17), as illustrated in FIG. 10.

The process continues, as illustrated in FIG. 11, with the deposition of a new metal layer forming a fin (20) extending from the central stud (17) as far as one side of the first electrode. This metal is deposited with a thickness approximately equal to that of the structuring layer (19) deposited on the other side of the electrode. The fin (20) illustrated in FIG. 11 is obtained after the metal deposited has undergone an etching step by a “lift off” technique. The metal fin (20) thus obtained is then protected by depositing a photoresist layer (21) covering its upper face.

Next, as illustrated in FIG. 12, the resist layer (21) is removed and then a structuring layer is deposited, this being observed only in the region (22) lying on one side of the electrode, away from the central trunk (23). The process continues by repeating the various steps, of depositing metal and then depositing a structuring layer, so as to obtain the structure illustrated in FIG. 13. The electrode then possesses therefore a tree structure formed from the various fins (25, 26) extending around the central trunk (27). Thus, a superposition of various fins is obtained, each having a thickness of around 150 angstroms. Of course, these dimensions are given as an example and can be modified according to the desired capacitance values.

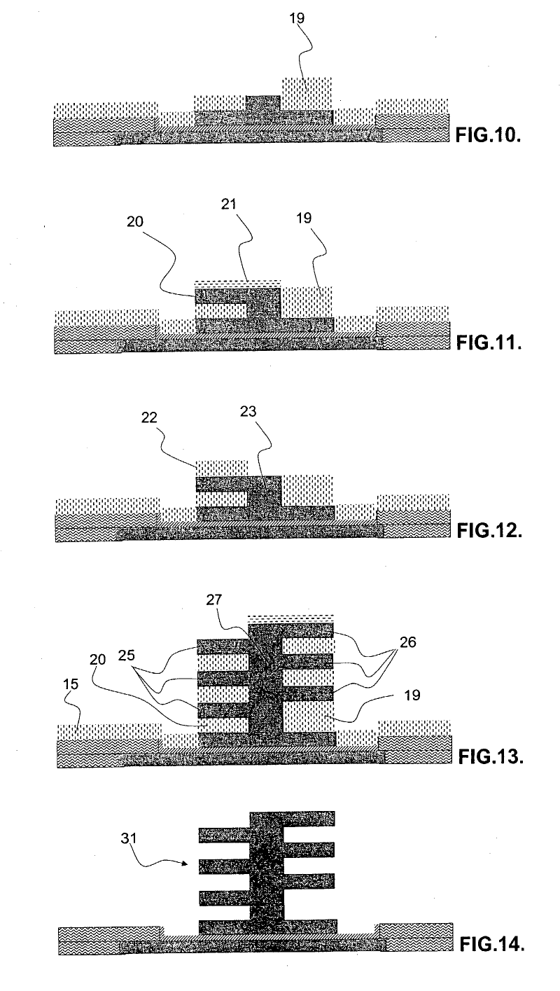

Next, the structuring layer (15) and the various portions of the structuring layers (19, 22) remaining between the fins (25, 26) are removed in order to obtain the structure illustrated in FIG. 14. This removal is accomplished by using a solvent dedicated to the formulation of the structuring layer.

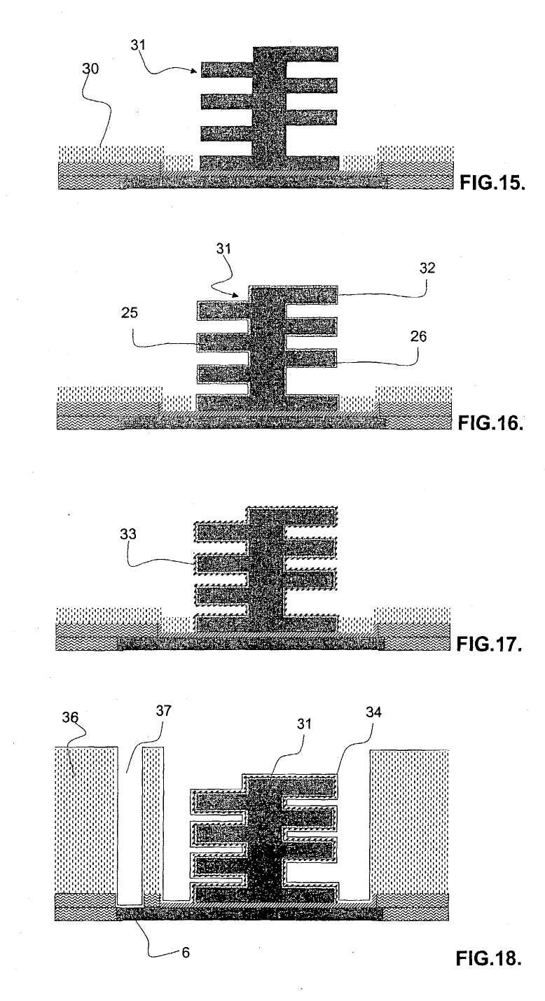

Next, as illustrated in FIG. 15, a new structuring layer (30) is deposited so as to protect that region of the microcomponent located outside the first electrode from future diffusion steps or subsequent deposition steps.

The process continues, as illustrated in FIG. 16, with the deposition of a barrier layer (32) covering the entire external surface of the first electrode (31), including in the spaces defined between the successive fins (25, 26).

Next, as illustrated in FIG. 17, a nanolaminate structure (33) formed from various ferroelectric and/or pyroelectric oxide layers is deposited. In one particular embodiment, the nanolaminate structure (33) may comprise a stack of eight different layers:

the first layer, having a thickness of 5 to 10 Å, is made from AlₓO₃₋ₓ, where x is between 0 and 3;

the second layer has a thickness of around 10 to 15 Å and is made from Ta_{z-2}O_{5-z}Al₂Oₓ, where z is between 0 and 2;

the third layer, with a thickness of around 15 to 20 Å, is made from TiO₂AlₓO_{3+y}, where y is between 0 and 3;

the fourth layer, with a thickness of around 40 to 100 Å, is made from TiO_{y-x}Ta_{z-2}O_{5+z};

the fifth layer, with a thickness of 60 to 200 Å, is made from TiO_{y}Ta_{3-z}O_{z}; and

the sixth, seventh and eighth layers are identical to the third, second and first layers, respectively.

The nanolaminate structure thus obtained has a thickness of between 200 and 400 Å. The relative permittivity of this layer is around 23.

Of course, the nanolaminate structure described above is a nonlimiting example in which certain elements can be substituted without departing from the scope of the invention.

Next, as illustrated in FIG. 18, a further structuring layer (36) is deposited, this being typically obtained from BCB, polyimide, Parylene® or Cyclotene®.

This structuring layer (36) is etched to define a trench (37) vertically in line with the interconnect (6) and in the region surrounding the electrode (31). A diffusion barrier layer (34), typically made of titanium nitride, is deposited over the entire structuring layer (36) and the electrode (31). If it is desired to produce the second electrode from electrolytic copper, a copper initiator layer is also deposited. This initiator layer is then covered on the upper faces of the portions of structuring layers (36) so as to prevent subsequent growth of the electrolytic copper.

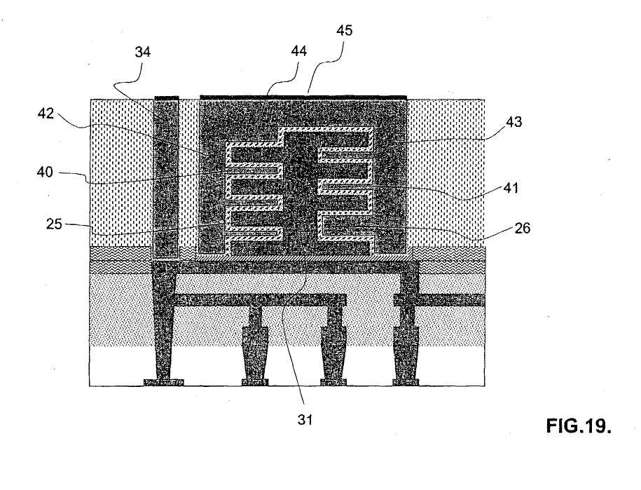

Next, as illustrated in FIG. 19, copper is deposited electrolytically so as to fill the trench (37) connected to the interconnect (6) and to fill the space defined around the first electrode (31).

The copper portion (38) deposited plumb with the interconnect (6) allows access, from the upper level of the component, to the interconnect (6) but also to the metallization level (3) to which the first electrode (31) is connected.

Deposition of electrolytic copper also makes it possible to form the second electrode filling the spaces lying between the various fins (25, 26) of the first electrode. This deposition therefore defines fins (40, 41) on either side of the first electrode. Some of these fins (40) are connected to a common wall (42), the other fins (41) being connected to another common wall (43).

The common walls (42, 43) are themselves connected to the upper level via a transverse portion (44), which also forms the connection pad of the upper electrode (45). It is also possible, as illustrated in FIG. 19, to deposit a passivation layer, typically made of chromium, or tantalum nitride, titanium nitride or molybdenum, covering both the portion (38) for linking to the first electrode and the second electrode (45).

To take an example, it is thus possible to produce microcapacitors having a capacitance in excess of 25 nanofarads per square millimeter, by defining fin thicknesses of the order of one micrometer, each of the fins having substantially a length of around 5 micrometers, the thickness of the central trunk being about 2.5 micrometers. It is possible to stack a large number of fins, typically more than 10. Of course, the numbers were given merely by way of nonlimiting example, and the invention encompasses many alternative embodiments.

As is apparent from the foregoing, the capacitors according to the invention may be obtained with very high capacitance values without incurring high costs regarding the procedure for producing them.

Furthermore, these microcapacitors have the advantage of being able to be used for subsequent operations carried out directly on the integrated circuit, since the two electrodes of the capacitor are accessible on the upper face of the microcomponents provided with the microcapacitor.

1. An electronic microcomponent produced from a substrate and incorporating a capacitive structure formed on the top of the final visible metallization level produced in the substrate, said capacitive structure having two electrodes, wherein one of the electrodes comprises an array of superposed fins that are offset from one another with respect to a central trunk, the other electrode comprising two arrays of fins, the fins of each of the latter arrays being interleaved with the fins of the first electrode and being joined together by a common wall, the two common walls themselves being joined together above the first electrode.

2. The microcomponent as claimed in claim 1, wherein the electrodes are separated by a dielectric layer made from materials chosen from the group of ferroelectric and/or pyroelectric oxides.

3. The microcomponent as claimed in claim 2, wherein the dielectric layer is formed by a superposition of elementary layers of different materials, forming a nanolaminate structure.

4. The microcomponent as claimed in claim 3, wherein the stoichiometry of the materials varies from one elementary layer of the nanolaminate structure to another.

5. The microcomponent as claimed in claim 1, wherein the surface of each electrode is covered with a layer of an oxygen diffusion barrier material.

6. The microcomponent as claimed in claim 1, wherein, for each electrode, the various fins are made from the same material.

7. The microcomponent as claimed in claim 6, wherein the electrodes are made of copper.

8. A process for fabricating a capacitive structure on a microcomponent produced from a substrate, said capacitive structure being fabricated on top of the final visible metallization level formed on the substrate, which process comprises the following steps, consisting in:
depositing, on top of the metallization level, a metal layer for forming the bottom part of one of the two electrodes of the capacitive structure;
depositing, on top of the metal layer, a structuring layer so as to define a channel for receiving a metal deposit;
depositing, in the channel thus formed, a metal deposit;
repeating the previous two steps, offsetting one on the other the position of the structuring layer in order to cover only part of the subjacent metal layer, so as also to offset the position of the metal deposits, and obtain a tree structure forming the first electrode;
depositing, on top of the first electrode, a layer of dielectric; and
depositing, over the first electrode, a conducting material that will insinuate between the metal layers of the first electrode, so as to form the second electrode.
